(19) United States
(12) Patent Application Publication
(10) Pub. No.: US 2023/0169138 A1
(43) Pub. Date: Jun. 1, 2023

(54) RENDERING PRIMITIVE CHILD ELEMENTS CORRESPONDING TO CHILD COMPONENTS OF A USER INTERFACE WITHOUT INSTANTIATING THE CHILD COMPONENTS

(71) Applicant: salesforce.com, inc., San Francisco, CA (US)

(72) Inventor: Adam Reineke, Redmond, WA (US)

(73) Assignee: salesforce.com, inc., San Francisco, CA (US)

(21) Appl. No.: 17/457,063

(22) Filed: Dec. 1, 2021

(51) Int. Cl. G06F 16/958; G06F 9/451; G06F 9/54

(52) U.S. Cl. CPC G06F 16/958; G06F 9/451; G06F 9/541

(57) ABSTRACT

Systems and methods are provided for rendering components of a user interface (UI) of an application such that primitive child elements that correspond to child components of the UI can be rendered without instantiating the child components. Each child data object corresponds to a particular child component of a parent component and includes data for that particular child component. Child data objects can be augmented to include a simple render method for rendering structured data of the augmented child data objects. The parent component be rendered from its template by iteratively evaluating each child data object and checking a property of that child data object to determine whether it includes a simple render method, and if so, the template of the parent component can instruct the framework to use that simple render method to get an atom object and render one or more primitive child elements.

### TECHNICAL FIELD

One or more implementations relate to the field of user interfaces and rendering components of a graphical user interface of a web application, and more specifically, relate to techniques for optimizing a rendering process by rendering primitive child elements corresponding to child components of a user interface without instantiating the child components to reduce performance overhead that is normally imposed by a framework so that the web application can render faster.

### BACKGROUND

Web applications and their associated graphical user interfaces (UIs) that run in browsers are typically built in compliance with various standards including HyperText Markup Language (HTML), Cascading Style Sheets (CSS), and scripting languages such as JavaScript, for example. HTML is the standard markup language for documents designed to be displayed in a web browser. HTML provides a means to create structured documents by denoting structural semantics for text such as headings, paragraphs, lists, links, quotes and other items. HTML declares the elements to be rendered by the browser. HTML can be assisted by technologies such as Javascript and CSS. HTML can embed programs written in a scripting language, such as JavaScript, which affects the behavior (interactivity) and content of web pages, and makes the elements interactive. Inclusion of CSS defines the look and layout of content, and modifies the appearance of the elements. In other words, HTML is used to represent the structure or content of a document, while CSS is responsible for its presentation.

UIs are built or composed of a multitude of nested components that are the building blocks a developer can use to compose an application. For example, a user interface (UI) can include one or more parent components, and each parent component can have a hierarchical tree structure that includes any number of child components. Each component can be composed of a collections of elements. Components enable abstraction and encapsulation and can also often track state or provide interactive functionality.

When a developer builds a UI of a web-based application, they typically do so using a component-based UI framework, such as React®, Angular®, Vue®, Lightning Web Run-time® (LWR), etc. A “UI framework” can refer to a collection of code that simplify developer experience building UIs and managing data. For instance, a UI framework can be a design program or other software that assists developers in building software projects. A UI framework can refer to a structure that holds together code written for defining UIs. For example, a UI framework can define a set of classes and interfaces that define the elements and behavior of a UI Subsystem. Frameworks often have specific, non-standard ways of defining components. One benefit of using a component-based framework is that it allows for the encapsulation of data and behavior. The UI framework manages overhead for each component. The framework handles things like updating a document object model (DOM) or running component lifecycle events, measured both in time taken and memory required.

One downside of using a component-based framework is that the framework can introduce performance overhead when an application loads and renders components of the UI. The impact of the overhead on application performance depends on the number of components that need to be rendered, and in general, the more components a UI has the slower the application renders. It would be desirable to provide technologies that can reduce time and cost required to load, run and render UI components so that applications can render faster.

The discussion above is merely provided for general background information and is not intended to be used as an aid in determining the scope of the claimed subject matter.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a computing system according to some example implementations;

FIG. 2 is a flow diagram illustrating a process for rendering components of a graphical user interface of a web application according to some example implementations;

FIG. 3 is a flow chart illustrating a method for configuring a parent component and child data object to implement a simple render method according to some example implementations;

FIG. 4 is a flow chart illustrating a method for rendering components of a graphical user interface of a web application according to some example implementations;

FIG. 5A is a block diagram illustrating an electronic device according to some example implementations; and

FIG. 5B is a block diagram of a deployment environment according to some example implementations.

### DETAILED DESCRIPTION

In one example of typical render process, when a web application loads and initializes in a browser, a framework can then load, instantiate, and render a parent component, and also load structured data and transform the structured data into a list of objects. The list of objects can then be bound to the parent component. The framework then iterates over the list of objects that have been bound to the parent component, and for every object, instantiates and renders child components.

Because UIs can vary in complexity, the number of components that a particular UI includes can vary widely. When the number of components to be rendered is relatively small (e.g., 50 or less), the totality of the overhead can be minimal. However, when a UI includes a large number of components, overhead imposed by the UI framework can become much more significant. For example, a single parent component of a UI, such as a large list or a table, may be composed of many child components (e.g., 1000s of child components). In cases where large numbers of trivial child components (e.g., ones that only display a value) are to be rendered, the framework overhead represents the majority of the cost to process and render these components.

The subject matter described herein generally relates to rendering components of a graphical user interface of a web application, and more particularly, techniques for optimizing the rendering process by reducing performance overhead that is normally imposed by a framework so that the web application can render faster. As used herein, the framework can be a UI framework, a web application development framework, or library.

Technologies are provided that can render primitive child elements (e.g., text strings, anchor elements, images, etc.) corresponding to child components of a user interface (UI) without instantiating the child components. A primitive child element can be, for example, an element having content that can be reduced to a basic HTML, element. When a child data object includes a simple render method (or API), a framework can render one or more primitive child elements without the framework having to instantiate a child component (or manage the child component) thereby reducing performance overhead that would normally otherwise be imposed by the framework so that the application can render faster. This saves time and resources needed to render components of a UI. In essence, it reduces overhead (time/speed and resources) that the UI framework would typically introduce by instantiating every child component in order to render the information the UI actually needs.

To explain further, when an application is loaded in a browser at run-time, a framework can load and instantiate a parent component without rendering the parent component, and also load structured data. The framework can transform the structured data into a list of child data objects to be bound to the parent component. Each child data object in the list corresponds to a particular child component of the parent component and includes data for that particular child component.

In accordance with the disclosed embodiment, a formatter augments selected ones of the child data objects to include a simple render method for rendering structured data of that child data object. The application binds the list of child data objects (including those that have been augmented with a simple render method) to the parent component. The framework can then render the parent component from the template of the parent component by iterating over each object in the list of objects. For each child data object in the list of child data objects that is bound to the parent component, the template can check a property on that child data object to determine whether that child data object includes a simple render method. When that child data object does not support a simple render method, the template of the parent component can instruct the framework to instantiate and render a child component.

By contrast, when that child data object does include a simple render method, the template of the parent component instructs the framework to use that simple render method from that child data object to get an atom object (that includes metadata that describes one or more primitive child elements) and render one or more primitive child elements without the framework having to instantiate a child component (or manage the child component) thereby reducing performance overhead that would normally otherwise be imposed by the framework so that the application can render faster.

In some embodiments, prior to run-time (e.g., during development), a simple render method is added to a child data object to extend an API of the child data object. The parent component is also modified so that it is configured to: (1) consume the simple render method on the child data object, (2) iterate over an atom object from the simple render method, and (3) render one or more primitive child elements within the template of the parent component based on metadata from the atom object that is retrieved from that extended API. The parent component can do this without instantiating (or managing) the child component thereby optimizing an overall process of rendering components. For example, in one implementation, a developer may define prior to run-time a set of primitive child element types for the parent component and at least one child component of the parent component. The set of primitive child elements each have a defined type and a correspond set of defined properties. A simple render method can then be added to a child data object that returns an atom object. The atom object includes metadata that describes one or more primitive child elements that should be rendered. The parent component can then be modified so that it is able to render primitive child elements within the template of the parent component using metadata from the atom object. As explained above, this saves time and resources needed to render components of a UI. In essence, the disclosed methodologies can reduce overhead (e.g., time/speed and management resources) that the UI framework would typically introduce by instantiating every child component in order to render the information the UI actually needs.

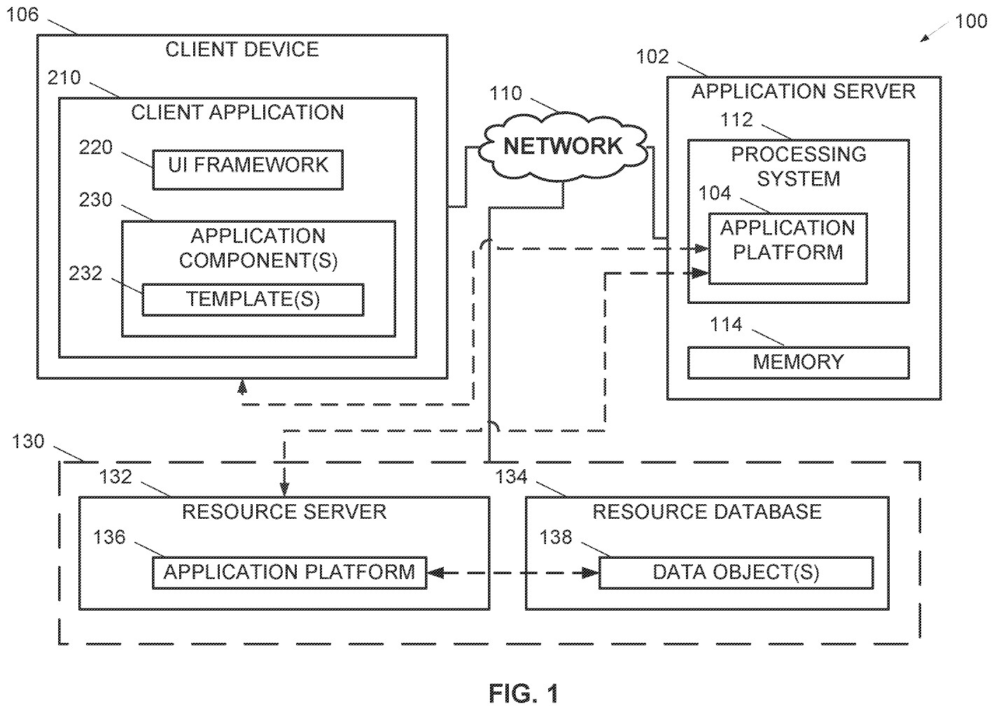

A non-limiting example of an environment in which the disclosed embodiments can be applied will now be described with reference to FIG. 1. FIG. 1 illustrates an exemplary computing system 100 for providing web applications over a network. It should be appreciated that FIG. 1 illustrates a simplified representation of the system 100 for purposes of explanation and is not intended to be limiting.

The illustrated system 100 includes an application server 102 that generally represents a server computing device, server computing system or another combination of processing logic, circuitry, hardware, and/or other components configured to support the processes, tasks, operations, and/or functions described herein. In this regard, the application server 102 supports an application platform 104 configurable to provide instances of one or more web applications within client applications 210 executed on client devices 106 communicatively coupled to the application server 102 via a communications network 110, such as the Internet or any sort or combination of wired and/or wireless computer network, a cellular network, a mobile broadband network, a radio network, or the like. The application server 102 generally includes a processing system 112, which may be implemented using any suitable processing system and/or device, such as, for example, one or more processors, central processing units (CPUs), controllers, microprocessors, microcontrollers, processing cores and/or other hardware computing resources configured to support the operation of the processing system described herein. The processing system 112 may include or otherwise access a data storage element 114 (or memory) capable of storing programming instructions for execution by the processing system, that, when read and executed, are configurable cause processing system 112 to create, generate, or otherwise facilitate the application platform 104 that generates or otherwise provides instances of a web application at run-time (or “on-demand”) based at least in part upon code and other data that is stored or otherwise maintained by the memory 114 or a remote location on the network 110 (e.g., at an external computing system 130). Depending on the implementation, the memory may be realized as a random access memory (RAM), read only memory (ROM), flash memory, magnetic or optical mass storage, or any other suitable non-transitory short or long term data storage or other computer-readable media, and/or any suitable combination thereof.

The client device 106 generally represents an electronic device coupled to the network 110 that may be utilized by a user to access and utilize an instance of a web application generated by the application platform 104 on the application server 102. In practice, the client device 106 can be realized as any sort of personal computer, mobile telephone, tablet, or other network-enabled electronic device. In exemplary implementations, the client device 106 includes a display device, such as a monitor, screen, or another conventional electronic display, capable of graphically presenting data and/or information provided by the web application along with a user input device, such as a touchscreen, a touch panel, a mouse, a joystick, a directional pad, a motion sensor, or the like, capable of receiving input from the user of the client device 106. The illustrated client device 106 executes or otherwise supports a client application 210 that communicates with the application platform 104 on the application server 102 using a networking protocol. In some implementations, the client application 210 is realized as a web browser or similar local client application executed by the client device 106 that contacts the application server 102 and/or the application platform 104 using a networking protocol, such as the hypertext transport protocol (HTTP) or the like, to access or otherwise initiate an instance of the web application being presented on the client device 106 (e.g., by or within the client application 210). For purposes of explanation, but without limitation, the client application 210 may alternatively be referred to herein as a browser application or web browser.

In the illustrated implementation depicted in FIG. 1, the external computing system 130 is realized as a database system that includes a resource server 132 communicatively coupled to the network 110 to support access to files, records, data, information, or other resources maintained in a resource database 134. In this regard, the resource server 132 generally represents a server computing device, server computing system or another combination of processing logic, circuitry, hardware, and/or other components configured to support remote access to data maintained in the resource database 134 via the network 110. In one or more implementations, the external computing system 130 is physically and logically distinct from the application server 102, for example, by residing at a different physical location than the application server 102. Additionally, the external computing system 130 may be owned, controlled, or otherwise operated by a third party that is different from the party that owns, controls and/or operates the application server 102 and/or the party that developed or is otherwise associated with the web application. That said, in some implementations, the external computing system 130 may be affiliated with the same party that owns, controls and/or operates the application server 102 and/or the application platform 104.

In one or more implementations, the external computing system 130 is realized as an on-demand multi-tenant database system that is capable of dynamically creating and supporting virtual applications based upon data from a common database 134 that is shared between multiple tenants, which may alternatively be referred to herein as a multi-tenant database. In accordance with one non-limiting example, the external computing system 130 is implemented in the form of an on-demand multi-tenant customer relationship management (CRM) system that can support any number of authenticated users of multiple tenants, for example, by providing, to any number of client devices, data and services generated by virtual applications at run-time (or on-demand) using a common application platform 136 that securely provides access to files, records, resources or other data objects 138 in the database 134 for each of the various tenants subscribing to the multi-tenant system. In this regard, one or more implementations of the external computing system 130 support one or more application program interfaces (APIs) at the resource server 132 that allow authorized and authenticated actors (e.g., the application server 102, the application platform 104, etc.) to retrieve or access data maintained in the database 134 that would otherwise be secured and inaccessible to unauthorized parties.

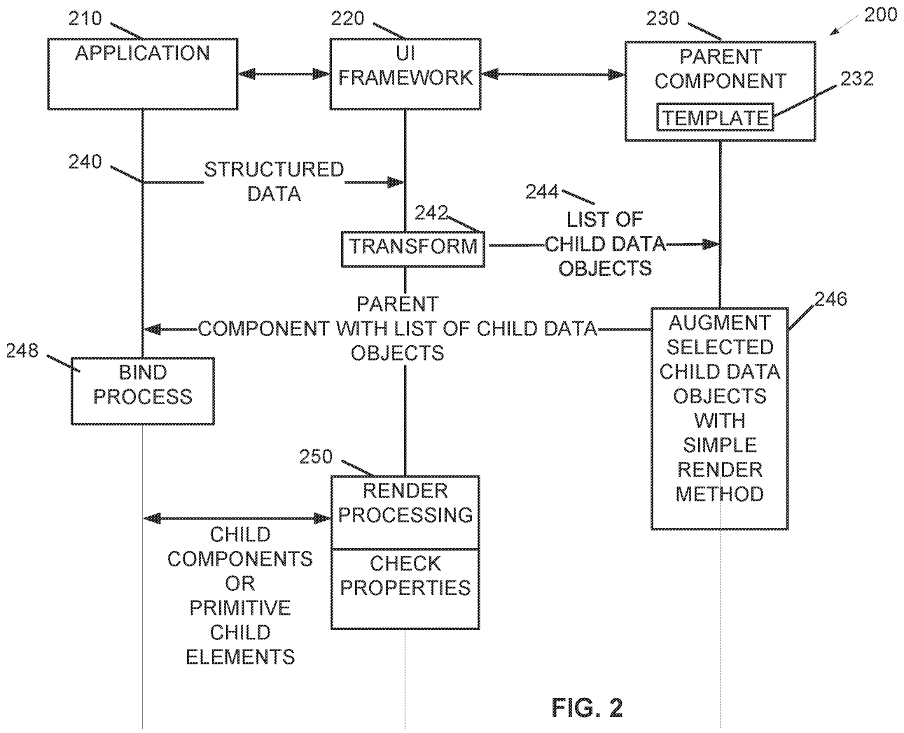

Still referring to FIG. 1, in exemplary implementations, the processing system 112 executes programming instructions that may cause the application platform 104 to create, generate, or otherwise facilitate a client application 210 at a client device 106 that allows a user to design or otherwise create web applications and corresponding web page GUI displays using the component template(s) 232. Additionally, in one or more implementations, the processing system 112 can execute programming instructions that can cause the application platform 104 to create, generate, or otherwise facilitate generating one or more web page GUI displays corresponding to a web application based on the configured application component(s) 230 associated with the web application. In this regard, the client application 210 can retrieve and render the configured application component(s) 230 at run-time to thereby provide an instance of the web application within the client application 210 at the client device 106. As will be described in greater detail below with reference to FIGS. 2-4, the client application 210 can use a UI framework 220 to instantiate one or more application component(s) 230 via template(s) 232 for each of the application component(s) 230.

The application component(s) 230 generally represent self-contained and reusable elements or other resources that may be added or otherwise incorporated into a web page and generated or otherwise rendered at run-time in accordance with user-defined or user-configured values for various metadata fields or parameters of the respective component template 232. For example, the application component(s) 230 may correspond to various GUI elements, such as buttons, text boxes, lists, menus, and/or the like, which may be added to a web page by a developer or other user.

An application component 230 may include presentation code (e.g., Hypertext Markup Language (HTML), cascading style sheet (CSS), and/or the like) defining the manner in which the application component 230 is to be displayed, rendered or otherwise presented by the client application 210. The application component 230 may also include behavioral code (e.g., JavaScript or other client-side executable code) defining the event-driven behavior of the application component 230 within the client application 210 (e.g., in response to user actions, server actions, an event associated with another web component, etc.). The application component 230 also includes the user-defined metadata values for the application component 230 which may be invoked, referenced, or otherwise utilized by the presentation code and/or behavioral code to generate and render the application component 230. Accordingly, the configured application component(s) 230 may be dynamic, with the content and/or behavior thereof varying each time a web page GUI display including one or more application component(s) 230 is viewed or accessed, for example, depending on the user of a client device 106 accessing the web application or other contextual information, in response to changes to data referenced and/or invoked by the application component(s) 230, and/or the like.

FIGS. 2-4 are flow diagrams and flow charts that illustrate examples of a process 200 and methods 300, 400 in accordance with the disclosed embodiments. With respect to FIGS. 2-4, the tasks, operations, acts and steps shown in each FIG. are not necessarily limiting. Tasks, operations, acts and steps can be added, omitted, and/or performed simultaneously without departing from the scope of the appended claims. Each process and method may include any number of additional or alternative tasks, operations, acts and steps, and the tasks, operations, acts and steps shown need not be performed in the illustrated order. Each process and method may be incorporated into a more comprehensive procedure or process having additional functionality not described in detail herein. Moreover, one or more of the tasks, operations, acts and steps shown could potentially be omitted from an embodiment of each process and method as long as the intended overall functionality remains intact. Further, each process and method is computer-implemented in that various tasks, operations, acts and steps that are performed in connection with each process and method may be performed by software, hardware, firmware, or any combination thereof. For illustrative purposes, the following description of each process and method may refer to elements mentioned above in connection with FIG. 1. In certain embodiments, some or all tasks, operations, acts and steps of the process and methods, and/or substantially equivalent tasks, operations, acts and steps, are performed by execution of processor-readable instructions stored or included on a processor-readable medium. For instance, in the description of FIGS. 2-4 that follows, an application, a UI framework, parent component, a template, etc. can be described as performing various tasks, operations, acts and steps, but it should be appreciated that this refers to processing system(s) of these entities executing instructions to perform those various tasks, operations, acts and steps. Depending on the implementation, some of the processing system(s) can be centrally located, or distributed among a number of server systems that work together.

As will now be described with reference to FIGS. 2-4, the disclosed embodiments provide technologies that can be used for rendering components of a graphical user interface of a web application. In accordance with the disclosed technologies, when a child data object includes a simple render method, a framework can render primitive child elements (e.g., text strings, anchor elements, images, etc.) corresponding to child components of a graphical UI without instantiating or managing the child components. A primitive child element can be, for example, an element having content that can be reduced to a basic HTML element.

As will be explained below, by refactoring a trivial child component to implement the simple render methods, and modifying a parent component to consume those simple render methods (or “extended APIs”), data of trivial child components can be provided through simple render methods and rendered by the parent component as primitive HTML elements. This approach can reduce time and cost required to load, run and render content of child components that have trivial behavior and trivial rendered data (e.g., “trivial child components”) so that an application can render faster. Examples of such trivial child components can include, but are not limited to, child components, such as ones that only display a value, an image, a link, other basic HTML elements, etc.

This approach saves time and usage of resources needed to render components of the UI by bypassing much of the performance overhead that would normally otherwise be imposed or introduced by the UI framework in instantiating every child component to render the information the UI needs. As such, the disclosed technologies can help optimize the rendering process by reducing performance overhead so that the web application can render faster. At the same time, when simple render methods are not implemented on the child component or the parent component does not use the simple render methods, the child component can also continue to be used in its normal manner (e.g., in standard situations), and the parent component can continue to render the child components in the normal manner.

FIG. 2 is a flow diagram illustrating a process 200 for rendering components of a graphical user interface of a web application according to some example implementations. In essence, the disclosed methodologies can reduce overhead (e.g., time/speed and management resources) that the UI framework would typically introduce by instantiating every child component in order to render the information the UI actually needs.

When an application 210 is loaded in a browser (not illustrated) at run-time, the framework 220 can load and instantiate a parent component 230 without rendering the parent component 230, and also load structured data at 240. As used herein, “structured data” can refer to any information that is received, generated or created by an application. The structured data can be received from many different sources depending on the implementation. For example, in one embodiment, the structured data is owned and managed by the application 210 and can be received by the application 210 in response to a request from the web application or framework 220. For example, in one non-limiting implementation, the application 210 can make a request to a server (not illustrated in FIG. 2) for the structured data (e.g., a JSON blob), and the server returns the structured data. In another implementation, the application 210 can receive the structured data, for example, by dragging and dropping a file. In another implementation, the application 210 can generate the data, for example, by processing data from other inputs. In another implementation, the application 210 can receive the structured data, for example, by user input.

At 242, the framework 220 can transform the structured data into a list of child data objects 244 to be bound to the parent component 230 via the application 210. Each child data object in the list corresponds to a particular child component of the parent component 230 and includes data for that particular child component.

At 246, a formatter (not illustrated) augments selected ones of the child data objects to include a simple render method for rendering structured data of that child data object. At 248, the application 210 binds the list of child data objects (including those that have been augmented with a simple render method) to the parent component 230.

At 250, the framework 220 can then render the parent component 230 from the template 232 of the parent component 230 by iterating over each object in the list of objects, and for each child data object in the list of child data objects is bound to the parent component 230, the template 232 can check a property on that child data object determine whether that child data object includes a simple render method. In one non-limiting embodiment, the template can be written in HTML, and describes the structure of a UI component, whereas the appearance (e.g., size, color, etc.) of the UI component can be defined by CSS.

When that child data object does not support a simple render method, the template 232 of the parent component 230 can instruct the framework 220 to instantiate and render a child component. By contrast, when that child data object does include a simple render method, the template 232 of the parent component 230 instructs the framework 220 to use that simple render method from that child data object to get an atom object and render one or more primitive child elements without the framework 220 having to instantiate or manage a child component thereby reducing performance overhead that would normally otherwise be imposed by the framework 220 so that the application 210 can render faster. Each atom object includes metadata (e.g., properties) that describe one or more primitive child elements (e.g., primitive HTML elements that are easily rendered). In this regard, it should be noted that a single primitive child element can be described by a single atom object, whereas one or more primitive child elements can be described by a list of atom objects.

HTML elements are the building blocks of HTML pages. HTML documents imply a structure of nested HTML elements. Each HTML element can have HTML attributes specified that define desired behavior or indicate additional element properties. Most attributes require a value. Each HTML element can also have content, including other elements and text. HTML elements are indicated or delineated in a HTML document by HTML tags that are written using angle brackets. For example, tags such as <img /> and <input /> directly introduce content into the page, whereas other tags such as <p> surround and provide information about document text and may include other tags as sub-elements. Browsers use HTML tags to interpret the content of the page. A list of HTML elements (with the exception of the main root element) is provided in Internet publication titled “HTML elements reference,” a copy of which is filed in an IDS with this application, and is incorporated by reference herein in its entirety. A copy of “HTML elements reference” can be obtained on the Internet at developer.mozilla.org/en-US/docs/Web/HTML/Element.

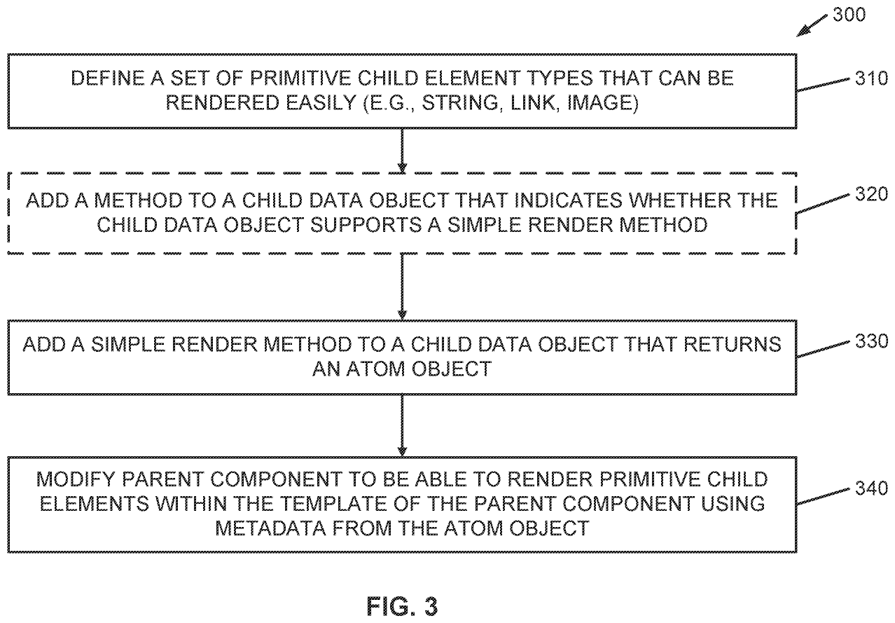

FIG. 3 is a flow chart illustrating a method 300 for configuring a parent component and child data object to implement a simple render method according to some example implementations. As will now be described with reference to FIG. 3, in some embodiments, prior to run-time (e.g., during development), a simple render method is added to a child data object to extend an API of the child data object. The parent component is also modified so that it is configured to: (1) consume the simple render method on the child data object, (2) iterate over an atom object from the simple render method, and (3) render one or more primitive child elements within the template of the parent component based on metadata from the atom object that is retrieved from that extended API. The parent component can do this without instantiating (or managing) the child component thereby optimizing an overall process of rendering components. In the description of FIG. 3 that follows an example will be described where a simple render method is added to a single child data object, but it should be appreciated that method 300 can be applied to any number of child data objects to add simple render methods to those child data objects.

Method 300 begins at 310, where a user, such as a developer, may define (e.g., prior to run-time) a set of primitive child element types for the parent component and at least one child component of the parent component. The set of primitive child element types (or “leaf node” types) may be either predetermined and hardcoded for both parent and child components, or dynamically maintained, similar to a dependency injection. For instance, the set of primitive child element types can include, without limitation, a string (e.g., text), anchor, image, and any other types for building static content on the web, etc. The definition of a child element type may specify any number of properties necessary for the parent to fully display the child element, including required, optional, or unused properties.

Primitive child elements are elements that can be easily rendered. Primitive child elements each have a defined type and a corresponding set of defined properties. For example, a primitive child element having a “link” type (used to render an HTML, anchor element) may have properties including “href,” and “value,” whereas a primitive child element having an “image” type may have properties including “src” and “alt.” While most primitive elements are HTML elements, other types of elements can also be utilized, such as, a string element.

At 320, which is optional, a method can be added to a child data object that indicates whether the child data object supports a simple render method. For example, in one implementation, a static method (includesBasicRender) can be added to a child data object that can be used to determine if the child data object could render data without needing to instantiate the corresponding child component. Step 320 is optional and could be omitted and inferred by a response from a simple render method.

At 330, a simple render method can then be added to a child data object so that it returns an atom object. The atom object includes metadata that describes one or more primitive child elements that should be rendered. The simple render method is added to a child data object to extend an API of a child data object so that the parent component can render one or more primitive child elements using an atom object retrieved from that API, without instantiating the child component, thereby optimizing an overall process of rendering components. For example, in one implementation of 330, a static method (basicValue) can be added to the child data object that takes the data and returns an atom object that describes what should be rendered. A benefit of this approach is that an author of a parent component can explicitly choose which primitive child elements it will render, and ignore attributes it either does not understand or chooses not to render. This opt-in model of support provides maximal security for the author of the parent component and the application.

At 340, the parent component can then be modified so that it is configured to render primitive child elements within the template of the parent component using metadata from an atom object. For example, in one embodiment, the parent component can be modified to consume the simple render method on the child data object, iterate over the atom object from the simple render method, and render the primitive child elements based on metadata from the atom object. By building the parent component to consume simple render methods (or “extended APIs”), where the trivial child components describe how they should be rendered, rather than a more direct rendering method such as, for example, directly returning detached DOM nodes to be inserted directly into the DOM tree, or returning raw HTML as text to be added directly to into the DOM tree, the parent component is able to have strict control over what primitive child elements are actually added to the document object model (DOM), which represents a document (e.g., HTML or XML document) as a logical tree structure wherein each node is an object representing a part of the document.

Another additional benefit of the disclosed embodiments is that the security threat of HTML injection is mitigated because the DOM element template is provided by the parent. All values from the child metadata are mapped into specific positions in the DOM as determined by the parent's template and never as raw HTML, which protects against a malicious child component attempting to insert dangerous attributes or HTML elements.

Another additional benefit of the disclosed embodiments is that they can allow event handlers to be added to primitive child elements when provided in the metadata and assigned in the parent component's template. Because the parent component's template is fully handled by the framework, the parent component can choose to assign properties or attributes, like event handlers, to primitive child elements within the parent component's template and know they will be handled without leaking memory.

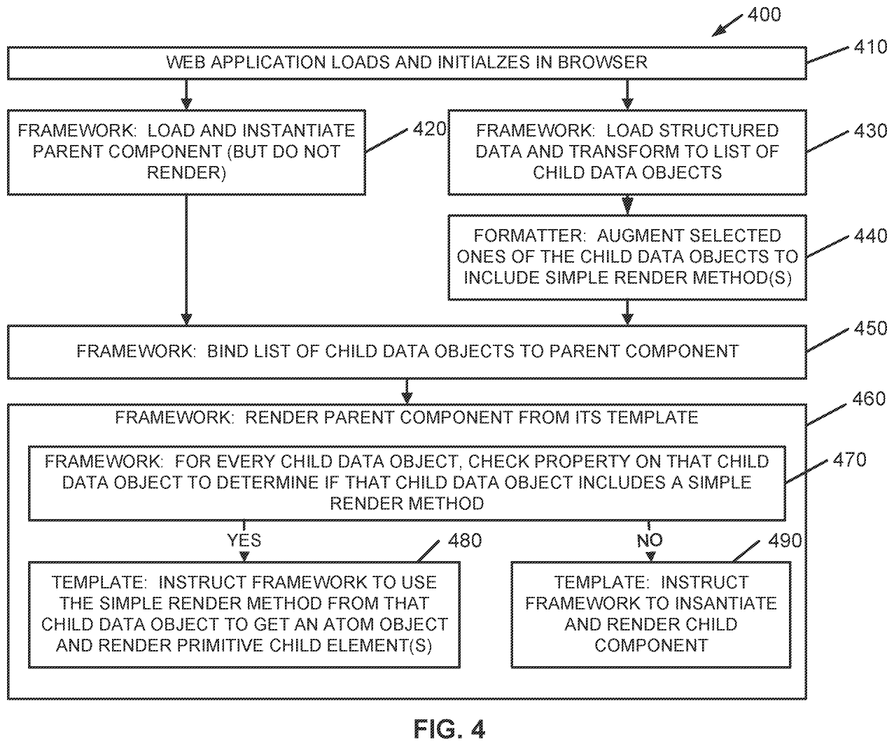

FIG. 4 is a flow chart illustrating a method 400 for rendering components of a graphical user interface of a web application according to some example implementations. The method 400 can begin at 410, when the web application is loaded in a browser at runtime, which triggers 420, 430. At 420, a framework can load and instantiate a parent component without rendering the parent component.

At 430, the framework can load structured data and transform the structured data into a list of child data objects to be bound to the parent component. For example, the structured data can be loaded by the framework in one format, and reorganized into another format that is expected by the parent component and allows it to be bound to (and understood by) the parent component as a list of child data objects.

Each child data object in the list corresponds to (e.g., maps to) a particular child component of the parent component and includes data for that child component. A child data object can be, for example, a subset of the structured data (representing only the data for a single child component, e.g., the smallest piece of data that describes the child component), transformed to a format that allows the framework and parent component to bind that piece of data to a child component.

At 440, a formatter can augment selected ones of the child data objects to include a simple render method for rendering structured data of that child data object. In one non-limiting embodiment, the formatter can be implemented at the parent component. The number of child data objects that are augmented can vary depending on the implementation. For example, in some cases, some of the child data objects of the parent component can be augmented, whereas in other cases, none or all of the child objects of the parent component can be augmented.

At 450, the application binds the list of child data objects to the parent component including the child data objects that have been augmented to include a simple render method.

At 460, the framework can render the parent component from a template of the parent component by iterating over each object in the list of child data objects. For each child data object in the list of child data objects that were bound to the parent component, the framework can check (at 470) a property on that child data object to determine whether that child data object includes a simple render method. When that child data object includes a simple render method, the method 400 can proceed to 480, where the framework can be instructed via the template of the parent component to use that simple render method from that child data object to get an atom object and render one or more primitive child elements within the boundaries of the parent component and without the framework instantiating or managing a child component thereby reducing performance overhead that would otherwise be imposed by the framework so that the web application can render faster. By contrast, when that child data object does not support a simple render method, the method can proceed to 490, where the framework can be instructed via the template of the parent component to instantiate and render a child component. Thus, when a simple render methods is not implemented, the child component can also continue to be used in its normal manner (e.g., in standard situations), and the parent component can continue to render the child components in the normal manner

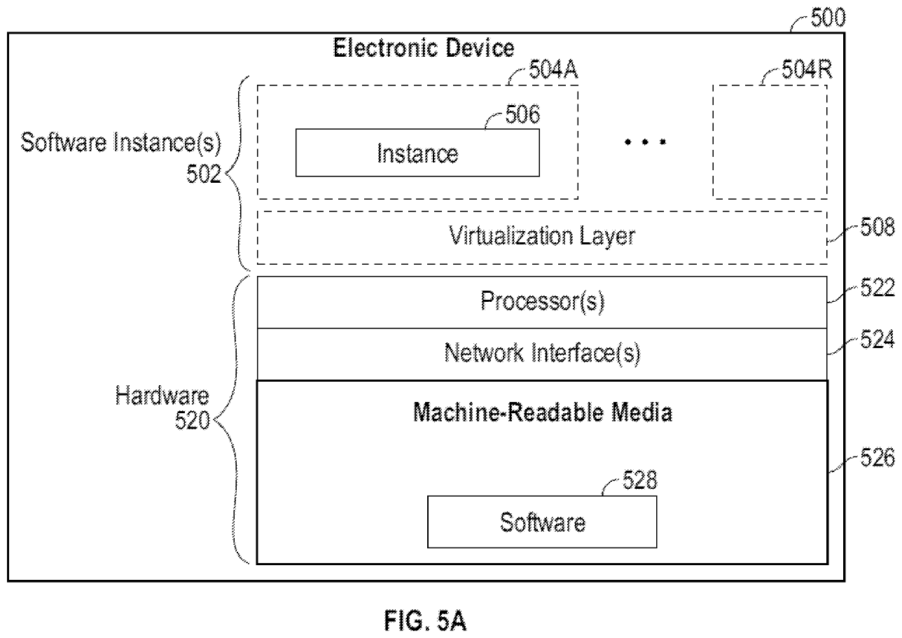

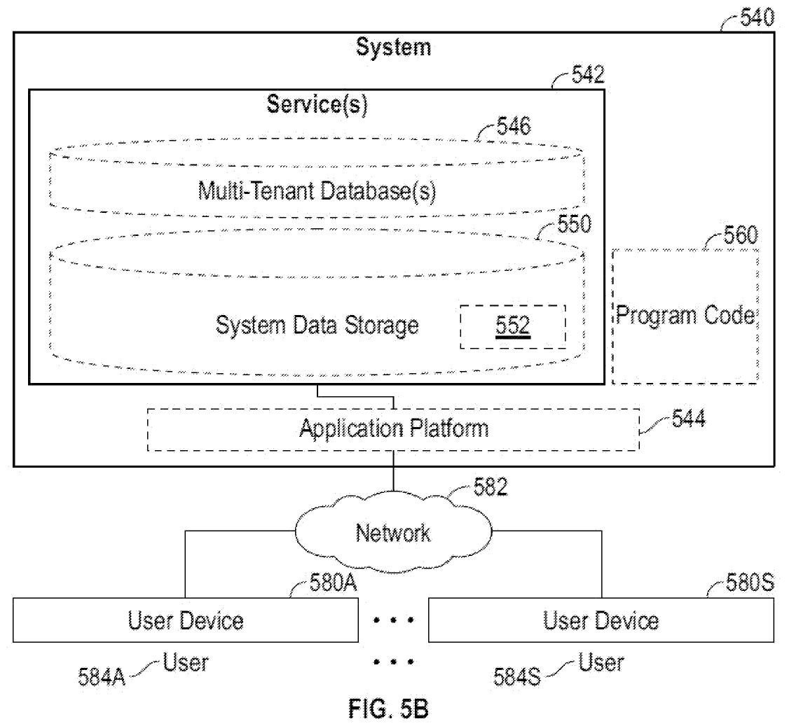

Referring now to FIGS. 5A-5B, one or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 5A is a block diagram illustrating an electronic device 500 according to some example implementations. FIG. 5A includes hardware 520 comprising a set of one or more processor(s) 522, a set of one or more network interfaces 524 (wireless and/or wired), and machine-readable media 526 having stored therein software 528 (which includes instructions executable by the set of one or more processor(s) 522). The machine-readable media 526 may include non-transitory and/or transitory machine-readable media. Each of the previously described clients and the web page design service may be implemented in one or more electronic devices 500. In one implementation: 1) each of the clients is implemented in a separate one of the electronic devices 500 (e.g., in end user devices where the software 528 represents the software to implement clients to interface directly and/or indirectly with the web page design service (e.g., software 528 represents a web browser, a native client, a portal, a command-line interface, and/or an application programming interface (API) based upon protocols such as Simple Object Access Protocol (SOAP), Representational State Transfer (REST), etc.)); 2) the web page design service is implemented in a separate set of one or more of the electronic devices 500 (e.g., a set of one or more server devices where the software 528 represents the software to implement the web page design service); and 3) in operation, the electronic devices implementing the clients and the web page design service would be communicatively coupled (e.g., by a network) and would establish between them (or through one or more other layers and/or or other services) connections for submitting authorization requests to the web page design service and returning access tokens to the clients. Other configurations of electronic devices may be used in other implementations (e.g., an implementation in which the client and the web page design service are implemented on a single one of electronic device 500).

During operation, an instance of the software 528 (illustrated as instance 506 and referred to as a software instance; and in the more specific case of an application, as an application instance) is executed. In electronic devices that use compute virtualization, the set of one or more processor(s) 522 typically execute software to instantiate a virtualization layer 508 and one or more software container(s) 504A-704R (e.g., with operating system-level virtualization, the virtualization layer 508 may represent a container engine (such as Docker Engine by Docker, Inc. or rkt in Container Linux by Red Hat, Inc.) running on top of (or integrated into) an operating system, and it allows for the creation of multiple software containers 504A-704R (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers 504A-504R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 528 is executed within the software container 504A on the virtualization layer 508. In electronic devices where compute virtualization is not used, the instance 506 on top of a host operating system is executed on the “bare metal” electronic device 500. The instantiation of the instance 506, as well as the virtualization layer 508 and software containers 504A-504R if implemented, are collectively referred to as software instance(s) 502.

Alternative implementations of an electronic device may have numerous variations from that described above. For example, customized hardware and/or accelerators might also be used in an electronic device.

FIG. 5B is a block diagram of a deployment environment according to some example implementations. A system 540 includes hardware (e.g., a set of one or more server devices) and software to provide service(s) 542, including the web page design service. In some implementations the system 540 is in one or more datacenter(s). These datacenter(s) may be: 1) first party datacenter(s), which are datacenter(s) owned and/or operated by the same entity that provides and/or operates some or all of the software that provides the service(s) 542; and/or 2) third-party datacenter(s), which are datacenter(s) owned and/or operated by one or more different entities than the entity that provides the service(s) 542 (e.g., the different entities may host some or all of the software provided and/or operated by the entity that provides the service(s) 542). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 540 is coupled to user devices 580A-580S over a network 582. The service(s) 542 may be on-demand services that are made available to one or more of the users 584A-584S working for one or more entities other than the entity which owns and/or operates the on-demand services (those users sometimes referred to as outside users) so that those entities need not be concerned with building and/or maintaining a system, but instead may make use of the service(s) 542 when needed (e.g., when needed by the users 584A-584S). The service(s) 542 may communicate with each other and/or with one or more of the user devices 580A-580S via one or more APIs (e.g., a REST API). In some implementations, the user devices 580A-580S are operated by users 584A-584S, and each may be operated as a client device and/or a server device. In some implementations, one or more of the user devices 580A-580S are separate ones of the electronic device 500 or include one or more features of the electronic device 500.

In some implementations, the system 540 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 540 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 540 may include an application platform 544 that enables PAAS for creating, managing, and executing one or more applications developed by the provider of the application platform 544, users accessing the system 540 via one or more of user devices 580A-580S, or third-party application developers accessing the system 540 via one or more of user devices 580A-580S.

In some implementations, one or more of the service(s) 542 may use one or more multi-tenant databases 546, as well as system data storage 550 for system data 552 accessible to system 540. In certain implementations, the system 540 includes a set of one or more servers that are running on server electronic devices and that are configured to handle requests for any authorized user associated with any tenant (there is no server affinity for a user and/or tenant to a specific server). The user devices 580A-580S communicate with the server(s) of system 540 to request and update tenant-level data and system-level data hosted by system 540, and in response the system 540 (e.g., one or more servers in system 540) automatically may generate one or more Structured Query Language (SQL) statements (e.g., one or more SQL queries) that are designed to access the desired information from the multi-tenant database(s) 546 and/or system data storage 550.

In some implementations, the service(s) 542 are implemented using virtual applications dynamically created at run time responsive to queries from the user devices 580A-580S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 560 may be a run-time engine that materializes application data from the metadata; that is, there is a clear separation of the compiled run-time engine (also known as the system kernel), tenant data, and the metadata, which makes it possible to independently update the system kernel and tenant-specific applications and schemas, with virtually no risk of one affecting the others. Further, in one implementation, the application platform 544 includes an application setup mechanism that supports application developers' creation and management of applications, which may be saved as metadata by save routines. Invocations to such applications, including the web page design service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 582 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 6^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 540 and the user devices 580A-580S.

Each user device 580A-580S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 540. For example, the user interface device can be used to access data and applications hosted by system 540, and to perform searches on stored data, and otherwise allow one or more of users 584A-584S to interact with various GUI pages that may be presented to the one or more of users 584A-584S. User devices 580A-580S might communicate with system 540 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 580A-580S might include an HTTP client, commonly referred to as a “browser,” for sending and receiving HTTP messages to and from server(s) of system 540, thus allowing users 584A-584S of the user devices 580A-580S to access, process and view information, pages and applications available to it from system 540 over network 582.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

1. A method for rendering components of a user interface (UI) of an application, the method comprising:
loading the application in a browser;
loading and instantiating a parent component by a framework;
loading structured data by the framework from the application;
transforming the structured data, by the framework, into a list of child data objects to be bound to the parent component by the application, wherein each child data object in the list of child data objects corresponds to a particular child component of the parent component and includes data for that particular child component, and wherein selected ones of the child data objects include a simple render method for rendering structured data of that child data object;
and
rendering the parent component from a template of the parent component by the framework by iterating over each child data object in the list of child data objects, the rendering comprising:
for each child data object in the list of child data objects that were bound to the parent component, checking a property of that child data object to determine whether that child data object includes a simple render method, and
when that child data object includes a simple render method, receiving instructions at the framework via the template of the parent component to use that simple render method from that child data object to get an atom object and render one or more primitive child elements.

2. A method according to claim 1, wherein each atom object comprises: metadata that describes one or more primitive child elements.

3. A method according to claim 1, wherein instructing,
comprises:
for each child data object in the list of child data objects that were bound to the parent component:
when that child data object includes a simple render method, receiving instructions at the framework via the template of the parent component to use that simple render method from that child data object to get an atom object and render one or more primitive child elements without the framework instantiating or managing a child component thereby reducing performance overhead that would otherwise be imposed by the framework so that the application can render faster.

4. A method according to claim 1, further comprising:
for each child data object in the list of child data objects that were bound to the parent component:
when that child data object does not support a simple render method, receiving instructions at the framework via the template of the parent component to instantiate and render a child component.

5. A method according to claim 1, wherein the loading and instantiating the parent component, comprises:
loading and instantiating the parent component without rendering the parent component.

6. A method according to claim 1, wherein the simple render method is added to a child data object to extend an API of the child data object so that the parent component can render one or more primitive child elements via the framework using the atom object retrieved from that API, without instantiating the child component, thereby optimizing an overall process of rendering components.

7. A method according to claim 6, wherein the parent component is modified so that it is configured to render one or more primitive child elements via the framework within the template of the parent component based on metadata from the atom object that is retrieved from that extended API.

8. A method according to claim 6, wherein the parent component is modified so that it is configured to: consume the simple render method on the child data object, iterate over the atom object from the simple render method, and render one or more primitive child elements within the template of the parent component based on metadata from the atom object that is retrieved from that extended API via the framework.

9. A method according to claim 1, further comprising:
prior to run-time:
defining a set of primitive child element types for the parent component and at least one child component, wherein the set of primitive child elements each have a defined type and a corresponding set of defined properties;
adding a simple render method to a child data object that returns an atom object, wherein the atom object comprises metadata that describes one or more primitive child elements that should be rendered; and
modifying the parent component to be able to render primitive child elements within the template of the parent component using metadata from the atom object via the framework.

10. A method according to claim 9, wherein the primitive child elements comprise one or more of:
a string;
an anchor element; and
an image.

11. A non-transitory machine-readable storage medium that provides instructions that, when executed by a processor, are configurable to cause said processor to perform operations for rendering components of a user interface (UI) of an application, the operations comprising:
loading the application in a browser;
loading and instantiating a parent component without rendering the parent component by the framework;
loading structured data by the framework from the application;
transforming the structured data by the framework into a list of child data objects to be bound to the parent component by the application, wherein each child data object in the list of child data objects corresponds to a particular child component of the parent component and includes data for that particular child component, and wherein selected ones of the child data objects include a simple render method for rendering structured data of that child data object;
and
rendering the parent component from a template of the parent component by the framework by iterating over each child data object in the list of child data objects, the rendering comprising:
for each child data object in the list of child data objects that were bound to the parent component checking a property of that child data object to determine whether that child data object includes a simple render method, and
when that child data object includes a simple render method, receiving instructions at the framework via the template of the parent component to use that simple render method from that child data object to get an atom object and render one or more primitive child elements.

12. The non-transitory machine-readable storage medium of claim 11, wherein each atom object comprises: metadata that describes one or more primitive child elements.

13. The non-transitory machine-readable storage medium of claim 11, wherein the instructions are configurable to cause said processor to perform operations comprising:
for each child data object in the list of child data objects that were bound to the parent component:
when that child data object includes a simple render method, receiving instructions at the framework via the template of the parent component to use that simple render method from that child data object to get an atom object and render one or more primitive child elements without the framework instantiating or managing a child component thereby reducing performance overhead that would otherwise be imposed by the framework so that the application can render faster.

14. The non-transitory machine-readable storage medium of claim 11, wherein the simple render method is added to a child data object to extend an API of the child data object so that the parent component can render one or more primitive child elements via the framework using the atom object retrieved from that API, without instantiating the child component, thereby optimizing an overall process of rendering components.

15. The non-transitory machine-readable storage medium of claim 14, wherein the parent component is configured to render primitive child elements within the template of the parent component via the framework using metadata from an atom object, and wherein the parent component is modified to consume the simple render method on the child data object, iterate over the atom object from the simple render method, and render the primitive child elements based on metadata from the atom object.

16. A system for rendering components of a user interface (UI) of an application, the system comprising:
a non-transitory machine-readable storage medium that stores software; and
at least one processor, coupled to the non-transitory machine-readable storage medium, to execute the software that is configurable to:
load the application in a browser;
load and instantiate a parent component without rendering the parent component by the framework;
load structured data by the framework from the application;
transform the structured data, by the framework, into a list of child data objects to be bound to the parent component, wherein each child data object in the list corresponds to a particular child component of the parent component and includes data for that particular child component, and wherein selected ones of the child data objects include a simple render method for rendering structured data of that child data object;
and
render the parent component from a template of the parent component by the framework by iterating over each child data object in the list of child data objects, the rendering comprising:
for each child data object in the list of child data objects that were bound to the parent component, check a property of that child data object to determine whether that child data object includes a simple render method, and
when that child data object includes a simple render method, receiving instructions at the framework via the template of the parent component to use that simple render method from that child data object to get an atom object and render one or more primitive child elements.

17. The system of claim 16, wherein each atom object comprises: metadata that describes one or more primitive child elements.

18. The system of claim 16, wherein the software is configurable to cause said processor to instruct the framework via the template of the parent component to use that simple render method from that child data object to get an atom object and render one or more primitive child elements without the framework instantiating or managing a child component thereby reducing performance overhead that would otherwise be imposed by the framework so that the application can render faster.

19. The system of claim 16, wherein the simple render method is added to a child data object to extend an API of the child data object so that the parent component can render one or more primitive child elements using the atom object retrieved from that API via the framework, without instantiating the child component, thereby optimizing an overall process of rendering components.

20. The system of claim 19, wherein the parent component is modified so that it is configured to: consume the simple render method on the child data object, iterate over the atom object from the simple render method, and render one or more primitive child elements within the template of the parent component via the framework based on metadata from the atom object that is retrieved from that extended API.
